(19) United States
(12) Patent Application Publication
(10) Pub. No.: US 2018/0181875 A1
(43) Pub. Date: Jun. 28, 2018

(54) MODEL SELECTION SYSTEM, MODEL SELECTION METHOD, AND STORAGE MEDIUM ON WHICH PROGRAM IS STORED

(71) Applicant: NEC Corporation, Mainako-ku Tokyo (JP)

(72) Inventors: Yousuke Motohashi, Tokyo (JP); Masato Asahara, Tokyo (JP); Satoshi Morinaga, Tokyo (JP)

(73) Assignee: NEC Corporation, Minato-ku, Tokyo (JP)

(21) Appl. No.: 15/128,539

(22) PCT Filed: Mar. 11, 2015
(86) PCT No.: PCT/JP2015/001313

§ 371 Date: Sep. 23, 2016

(51) Int. Cl. G06N 99/00; G06N 5/04; G06Q 30/02

(52) U.S. Cl. CPC G06N 99/005; G06Q 30/0283; G06N 5/04

(57) ABSTRACT

In this invention, a property of a prediction target or analysis target can be predicted or analyzed with a high degree of precision during a transition from a stage in which there is extremely little or no known data about said prediction target or analysis target to a stage in which a sufficient amount of known data has been accumulated. This learning-model selection system comprises a model-evaluating means for evaluating learning models and a model-selecting means for selecting either a target learning model or a higher-order learning model on the basis of the result of the evaluation.

### TECHNICAL FIELD

The present invention relates to data mining.

### BACKGROUND ART

Data mining may be used for the purpose of predicting unknown information, discovering new knowledge, finding an optimal solution for solving a problem, and detecting data different than usual on the basis of known data.

PTL 1, PTL 2, and PTL 3 disclose examples of technologies of predicting unknown information on the basis of known data.

PTL 1 discloses a device that predicts a power demand quantity in the future in a certain building. Hereinafter, a building that is a prediction target of a power demand quantity is referred to also as a “target building”. The device disclosed in PTL 1 includes a data storage unit and a prediction processing unit.

The data storage unit stores a power demand quantity in the past in the target building on a daily basis. More specifically, the data storage unit stores data in which the power demand quantity in a day is associated with a value indicating, for example, the highest temperature in the day, and the like. The value indicating the highest temperature can be considered as one of factors on which the power demand quantity depends. The data storage unit, for example, stores the data for the last one month.

The prediction processing unit generates a learning model for the target building on the basis of the data stored in the data storage unit. The learning model is information indicating regularity found between the values indicating the highest temperatures (an explanation variable) and the power demand quantities (an objective variable). The prediction processing unit generates the learning model by using a method such as regression analysis. The learning model, for example, is a function of receiving values indicating the explanation variable as input and outputting a prediction result.

In the following description, a case in which the forecasting processing unit forecasts a power demand quantity for the next day is assumed. The forecasting processing unit, for example, acquires a value indicating the highest temperature on the next day with reference to weather forecast and the like. The forecasting processing unit inputs the value indicating the highest temperature on the next day to the learning model. By so doing, the learning model forecasts the power demand quantity for the next day in the target building. In the following description of the present application, inputting, for example, a value to a device such as an information processing device, which operate on the basis of the learning model, is also written as “inputting a value to the learning model” as described above. Forecasting, for example, an quantity by the device such as an information processing device, which operate on the basis of the learning model, is also written as “forecasting an quantity by the learning model” as described above.

As described above, on the basis of data indicating power demand quantities in the past in a building to be forecasted (that is, a target building), the device disclosed in PTL 1 generates a learning model for the target building. The device disclosed in PTL 1 forecasts a power demand quantity of the future in the target building by using the learning model.

PTL 2 discloses an apparatus that estimates a proper price when a certain book is sold as a used book. The proper price is the highest price within a range in which the used book is sold in market transactions. Hereinafter, a used book that is an estimation target is also written as a “target used book”. The apparatus disclosed in PTL 2 acquires a transaction result price when a book (that is, the same book), which has an ISBN (International Standard Book Number) equal to an ISBN assigned to the target used book, is sold in the past as a used book. The apparatus disclosed in PTL 2 estimates a proper price of a target used book by using the values indicating the transaction result prices as one of explanation variables.

PTL 3 discloses a device that estimates the price of real estate. Hereinafter, real estate that is an estimation target is also written as a “target real estate”. The device disclosed in PTL 3, for example, extracts real estate similar to the target real estate from real estate existing in a neighboring area of the target real estate. The device disclosed in PTL 3 estimates the price of the real estate that is the estimation target with reference to a price and the like when the similar real estate is transacted in the past.

### CITATION LIST

### Patent Literature

[PTL 1] Japanese Unexamined Patent Application Publication No. 2013-255390

[PTL 2] Japanese Unexamined Patent Application Publication No. 2011-43970

[PTL 3] Japanese Unexamined Patent Application Publication No. 2003-22314

### SUMMARY OF INVENTION

### Technical Problem

According to the device disclosed in PTL 1, it is not possible to forecast a power demand quantity on the next day in a newly constructed building. This is because there is no data indicating power demand quantities in the past in the newly constructed building. By using data indicating power demand quantities of the past in the target building, the device disclosed in PTL 1 generates a forecasting model for forecasting the power demand quantity on the next day in the building. However, when the newly constructed building is the target building, there is no data indicating power demand quantities in the past in the target building. Therefore, the device disclosed in PTL 1 is not able to generate a forecasting model for forecasting the power demand quantity on the next day in the newly constructed building. Accordingly, the device disclosed in PTL 1 is not able to forecast the power demand quantity on the next day in the newly constructed building. When data indicating the power demand quantities in the past in the target building is not sufficiently accumulated, the device disclosed in PTL 1 is not able to forecast a power demand quantity on the next day in the target building accurately.

According to the apparatus disclosed in PTL 2, with respect to a book not sold as an old book in the past, it is difficult to accurately estimate a proper price at which the book is sold as a used book. This is because, if a book that is identical to a target used book has not been sold as a used book, the apparatus disclosed in PTL 2 is not able to acquire a transaction result price. A value indicating the transaction result price is one of important explanation variables when estimating a proper price. When past transaction results of the book that is identical to the target used book as a used book is not sufficiently accumulated, the apparatus disclosed in PTL 2 has difficulty in estimating a proper price of the target used book accurately.

As described above, in a stage that is not a stage in which data of the past (that is, known data) for a forecasting target is sufficiently accumulated, both the device disclosed in PTL 1 and the apparatus disclosed in PTL 2 have difficulty in forecasting future or unknown properties of the forecasting target accurately.

The device disclosed in PTL 3 estimates the price of real estate as described above. When considering the properties of a transaction object called real estate, a transaction opportunity of target real estate is very limited. For real estate that is an estimation target, sufficiently accumulating data of past transaction results of the real estate is not easy to think in the real estate industry. When the device disclosed in PTL 3 estimates the price of real estate, it is not considered that a price at which the target real estate is sold in the past is used as an explanation variable.

One of the objects of the present invention is to accurately predict a property of a prediction target during a process of a transition from a stage in which there is extremely little or no known data for the prediction target to a stage in which a sufficient amount of known data for the prediction target is accumulated.

In the aforementioned description, in order to facilitate understanding, the technical problem is described using an example of data mining for the purpose of “prediction”. However, the technical problem is not limited to the “prediction”.

Another object of the present invention is to accurately analyze a property of an analysis target during a process of a transition from a stage in which there is extremely little or no known data for the analysis target to a stage in which a sufficient amount of known data for the analysis target is accumulated.

### Solution to Problem

A first aspect of the present invention is learning model selection system including: model evaluation means for evaluating a learning model; and model selection means for selecting one learning model from a target learning model and a higher-order learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the higher-order learning model is a learning model generated on a basis of a higher-order data set which is a set of a plurality of pieces of the target data and a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

A second aspect of the present invention is learning model selection method including: evaluating a learning model; and selecting one target model from a target learning model and a higher-order learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the higher-order learning model is a learning model generated on a basis of a higher-order data set which is a set of a plurality of pieces of the target data and a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

A third aspect of the present invention is computer readable storage medium storing a program causing a computer to execute: first processing of evaluating a learning model; and second processing of selecting one learning model from a target learning model and a higher-order learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the higher-order learning model is a learning model generated on a basis of a higher-order data set which is a set of a plurality of pieces of the target data and a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

A fourth aspect of the present invention is learning model selection system including: model evaluation means for evaluating a learning model; and model selection means for selecting one learning model from a target learning model and a similar learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the similar learning model is a learning model generated on a basis of a similar data set which is a set of one or a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

A fifth aspect of the present invention is learning model selection method including: evaluating a learning model; and selecting one learning model from a target learning model and a similar learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the similar learning model is a learning model generated on a basis of a similar data set which is a set of one or a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

A sixth aspect of the present invention is computer readable storage medium storing a program causing a computer to execute: first processing of evaluating a learning model; and second processing of selecting one learning model from a target learning model and a similar learning model on a basis of a result of the evaluation, wherein the learning model is information representing regularity found between values of an objective variable and values of an explanation variable explaining the values of the objective variable, the target learning model is a learning model generated on a basis of a target data set which is a set of a plurality of pieces of target data, the similar learning model is a learning model generated on a basis of a similar data set which is a set of one or a plurality of pieces of similar data, the target data is information in which values of an objective variable for a specific target are associated with values of an explanation variable explaining the values of the objective variable, and the similar data is information in which values of an objective variable for a target similar to the specific target are associated with values of an explanation variable explaining the values of the objective variable.

Furthermore, an object of the present invention is also achieved by a program stored in the aforementioned computer readable storage medium.

### Advantageous Effects of Invention

According to the present invention, it is possible to accurately predict a property of a prediction target during a process of a transition from a stage in which there is extremely little or no known data for the prediction target to a stage in which a sufficient amount of known data is accumulated.

Furthermore, according to the present invention, it is possible to analyze a property of an analysis target accurately during a process of a transition from a stage in which there is extremely little or no known data for the analysis target to a stage in which a sufficient amount of known data is accumulated.

### BRIEF DESCRIPTION OF DRAWINGS

FIG. 1 is a diagram illustrating a specific example of a semantic hierarchical model according to a first exemplary embodiment of the present invention.

FIG. 2 is a diagram illustrating a graph indicating a transition of accuracy of a prediction target learning model and a higher-order learning model during a process of the accumulation of prediction target data according to the first exemplary embodiment of the present invention.

FIG. 3 is a block diagram illustrating a configuration of a model selection system 100 according to the first exemplary embodiment of the present invention.

FIG. 4 is a diagram illustrating an example of a hardware configuration with which the model selection system 100 according to the first exemplary embodiment of the present invention is achieved.

FIG. 5 is a flowchart illustrating an example of an operation of the model selection system 100 according to the first exemplary embodiment of the present invention.

FIG. 6 is a diagram illustrating another example of a semantic hierarchical model according to the first exemplary embodiment of the present invention.

FIG. 7 is a block diagram illustrating a configuration of a model selection system 100A according to a second exemplary embodiment of the present invention.

FIG. 8 is a block diagram illustrating a configuration of a model selection system 100B according to a third exemplary embodiment of the present invention.

### DESCRIPTION OF EMBODIMENTS

In order to facilitate understanding, the technical problem will be described in detail by using a specific example. The specific example is an example in which a prediction system predicts a power demand quantity on the next day in a newly constructed building. Hereinafter, this newly constructed building, which is a prediction target of the power demand quantity, is also written as a “target building”.

A newly constructed building in the following description is an example of a building in which power demand quantity data is not obtained yet. The target building may not be a newly constructed building, if data including values indicating power demand quantities are not accumulated for the target building. In the following description, a “new construction day” may be, for example, a day on which a constructed building starts to be used. The “new construction day” may be a day on which the prediction system starts to accumulate data including values indicating a power demand quantities of a target building. The “new construction day” is also referred to as a “first day after new construction”.

The prediction system, for example, continuously accumulates, for each day from a new construction day, data in which a value indicating a daily-based power demand quantity on a day in a target building is associated with a value indicating, for example, the highest temperature on the day, or the like. The highest temperature is one of factors for determining a power demand quantity. In the present specific example, the value indicating the power demand quantity is a value of an objective variable. The value indicating the highest temperature is a value of an explanation variable. Hereinafter, data of one day is written as “known data”. A set of the known data is written as a “known data set”. The known data set, for example, is a set of known data in one month of the past.

The prediction system generates a learning model on the basis of the known data set. In this case, the learning model is information indicating regularity found between values indicating the power demand quantity and values indicating the highest temperature. The prediction system predicts a power demand quantity on the next day by using the learning model.

The “next day” is, for example, the next day of a day on which power demand indicated by a value of the newest power demand quantity occurs, which is included in the “known data set” used to generate a learning model to be used for predicting a power demand quantity. The “next day” may be, for example, a day after the next day of the day on which the power demand indicated by the value of the newest power demand quantity occurs.

Hereinafter, a “process of a transition from a stage in which there is extremely little or no known data for a prediction target to a stage in which a sufficient amount of known data for the prediction target is accumulated” will be described with divided three stages of the following (stage 1), (stage 2), and (stage 3).

(Stage 1): The stage 1 is a stage in which there is no known data for the prediction target. In the present specific example, the stage 1 is a first day after new construction. In this stage, the prediction system is not able to generate a learning model for a target building. This is because there is no data indicating a power demand quantity in the past in the target building (that is, known data).

Accordingly, the prediction system extracts a plurality of buildings having properties similar to those of the target building. Assume that a power demand quantity of the building strongly depends on, for example, the conditions of exposure to the sun of the building (that is, sunshine conditions) and the business type of a tenant in the building. The prediction system extracts a building which has sunshine conditions similar to those of the target building and which has a tenant having a business type which is the same as or similar to that of a tenant scheduled to be set up in the target building. Hereinafter, the extracted one building or a plurality of buildings are called a “set of similar buildings”. The set of similar buildings includes the target building itself.

Then, the prediction system acquires a known data set indicating a power demand quantities in the past in the set of similar buildings. On the basis of the acquired known data set, the prediction system generates a “learning model for the set of similar buildings”. Then, the prediction system predicts a power demand quantity on the next day in the target building by using the “learning model for the set of similar buildings”. Hereinafter, the “learning model for the set of similar buildings” will be called a “higher-order learning model” of the target building.

As described above, in the stage in which there is no known data for a target building, the prediction system predicts a power demand quantity on the next day in the target building by using the higher-order learning model of the target building.

(Stage 2): The stage 2 is a stage in which there is very little known data for the prediction target. In the present specific example, the stage 2 is a stage in which, for example, several days are from the stage 1. In this stage, the prediction system has known data for the several days after the stage 1. On the basis of the known data for the several days, the prediction system is able to generate a learning model for the target building. Hereinafter, a learning model generated on the basis of known data for the target building itself is referred to as a “prediction target learning model” for the purpose of distinguishing it from the higher-order learning model.

In general, in order to generate an accurate learning model, a sufficient amount of known data is required. In this stage, since the amount of the known data for the target building itself is very little, accuracy of the prediction target learning model is low. On the contrary, since the amount of the known data in the set of similar buildings is large, the accuracy of the higher-order learning model is high.

Accordingly, in this stage, the prediction system is able to predict the power demand quantity on the next day in the target building accurately by using the higher-order learning model instead of the prediction target learning model.

(Stage 3): The stage 3 is a stage in which a sufficient amount of known data for the prediction target is accumulated. In the present specific example, the stage 3 is a stage in which, for example, several months pass from the stage 1 for example. In this stage, the prediction system is able to predict the power demand quantity on the next day in the target building accurately by using the prediction target learning model instead of the higher-order learning model.

This is because the prediction target learning model is generated on the basis of a sufficient amount of known data in this stage. Accordingly, the prediction target learning model is regarded to have a sufficient accuracy. The higher-order learning model is also generated on the basis of a sufficient amount of known data, but is just a model generated on the basis of a data set in which known data for buildings similar to the target building is mixed. Therefore, if the prediction target learning model is generated on the basis of a sufficient amount of known data, it is considered that a power demand quantity on the next day in the target building is able to be predicted accurately according to the prediction target learning model.

A description is given above for the “process of the transition from the stage in which there is very little or no known data for a prediction target to the stage in which a sufficient amount of known data for the prediction target is accumulated” by using a specific example.

In the process of the transition from the stage in which there is very little known data for a prediction target (that is, the stage 2) to the stage in which a sufficient quantity of known data for the prediction target has been accumulated (that is, the stage 3), the present inventor has found that the following problem exists when predicting a future or unknown property of the prediction target accurately.

That is, in the aforementioned process, the present inventor has found that it is important to switch a learning model that is used when predicting an unknown property of a prediction target from a higher-order learning model to a prediction target learning model at an appropriate timing.

Hereinafter, exemplary embodiments of the present invention capable of solving such a problem will be described in detail with reference to the drawings.

### First Exemplary Embodiment

In order to facilitate understanding, the following terms are defined.

(Known data): The known data is information in which a value of an objective variable is associated with a value of an explanation variable explaining the value of the objective variable.

(Known data set): The known data set is a set of a plurality of pieces of known data.

(Learning model): The learning model is information indicating regularity found between values of the objective variable and values of the explanation variable explaining the values of the objective variable. The learning model is generated on the basis of the known data set. The learning model is used for the following uses for example.

1) In order to predict unknown information (i.e. prediction: including regression, determination and the like)

2) In order to discover useful knowledge (i.e. knowledge discovery)

3) In order to discover an optimal solution for solving a problem (i.e. optimization)

4) In order to find sample data different from normal data (i.e. abnormality detection)

In the present exemplary embodiment, in order to facilitate understanding, an example in which a learning model is used for prediction is described. However, in the present invention, the use of the learning model is not limited only to prediction. When the learning model is used for prediction, the learning model is a function receiving a value of an explanation variable as input and predicting a value of an objective variable. Hereinafter, the value of the objective variable predicted by the learning model is referred to as a “predicted value”.

(Prediction target data): The prediction target data is known data for a prediction target. The prediction target data is an example of “target data” described in Claims.

(Prediction target data set): The prediction target data set is a set of prediction target data. The prediction target data set is an example of a “target data set” described in Claims.

(Similar data): The similar data is known data for an object similar to a prediction target.

(Higher-order data set): The higher-order data set is a set of prediction target data and similar data. In other words, the higher-order data set is a data set including a set of prediction target data and a set of similar data.

(Prediction target learning model): The prediction target learning model is a learning model generated on the basis of a prediction target data set. The prediction target learning model is an example of a “target learning model” described in Claims.

(Higher-order learning model): The higher-order learning model is a learning model generated on the basis of a higher-order data set. The higher-order learning model can be regarded as a model positioned at a higher rank than a target learning model.

Hereinafter, a first exemplary embodiment will be described using an example of a system in which a dealer of used items (hereinafter, written as a “provider”) predicts a proper price when selling a certain item as a used item. The proper price is the highest price within a range in which the used item is sold in market transactions.

The used items are items dealt secondhand. The used items, for example, are smart phones, cellular phones, PCs (Personal Computers), cameras, wrist watches, golf clubs, clothes and the like. The used items are not limited to the above examples.

In the first exemplary embodiment, the “known data” is information obtained by associating a price when a certain item has been actually sold as a used item (that is, a transaction result price) with a factor for determining the price. In the following description, an actual selling price is written as a transaction result price or is simply written as a price.

In the first exemplary embodiment, the transaction result price is an objective variable. The factor for determining the transaction result price (that is, the price) is an explanation variable. As the factor for determining the price, for example, there are various factors such as the presence or absence of defects and colors of items. In the first exemplary embodiment, one piece of known data corresponds to a transaction result of one used item.

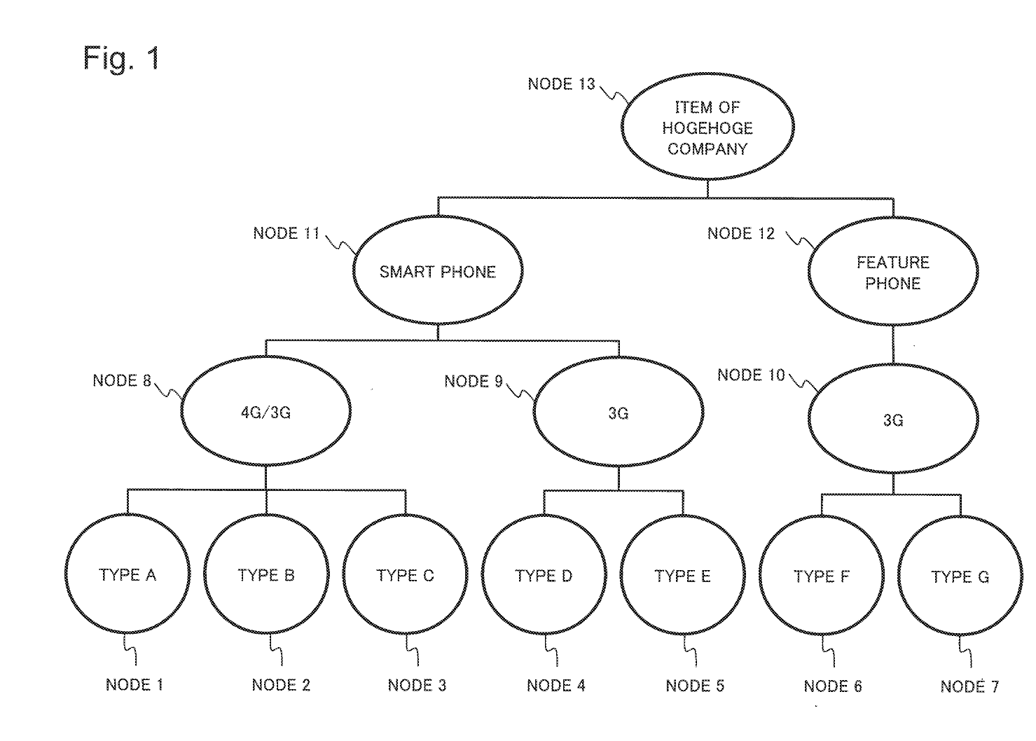

FIG. 1 is a diagram schematically illustrating a specific example of types and attributes of the types, which is represented by a semantic hierarchical model. Attributes in the semantic hierarchical model may be common to explanation variables or not. In the example illustrated in FIG. 1, the semantic hierarchical model has a tree structure.

In the example illustrated in FIG. 1, an item is a cellular phone including a smart phone and a feature phone.

In the semantic hierarchical model represented by a tree structure in FIG. 1, each of nodes 1 to 7 corresponding to leaf nodes indicates a type. A type indicates, for example, a model of an item, which is distinguished by the same model name. The below-described type A, type B, type C, type D, type E, type G and the like indicate names of types (for example, model names), respectively. In the following description, for example, an “item of the type A” may be an item to which a name that is the type A is assigned. When an item is the item of the type A, the item is also written so as to belong to the type A. Even if the same name is assigned to items, when model numbers assigned to the items are different from each other, types of the items may be different from each other. A node, other than the leaf nodes, indicates a group of types, which is grouped one or more times of grouping according to, for example, attributes. In the following description, an ancestor group of a node indicating a type is also referred to as a higher-order group of the type. The type belongs to each higher-order group of the type. In the example illustrated in FIG. 1, a node 13 indicates a manufacturing company of items of these types. In the example illustrated in FIG. 1, a node 11 and a node 12 indicate groups of types of, for example, smart phones, feature phones and the like. A node 8, a node 9, and a node 10 indicate groups of types according to a standard of mobile communication (hereinafter, also referred to as a communication standard) supported by terminals of the types.

For example, the item of the type A, the item of the type B, and the item of the type C illustrated in FIG. 1 are items manufactured by Hogehoge Company and are smart phones supporting 4G (Generation) and 3G communication standards. That is, the type B and the type C can be said as types similar to the type A. For example, the item of the type D and the item of the type E illustrated in FIG. 1 are items manufactured by Hogehoge Company and are smart phones supporting the 3G communication standard and not supporting the 4G communication standard. For example, the item of the type F and the item of the type G illustrated in FIG. 1 are items manufactured by Hogehoge Company and are feature phones supporting the 3G communication standard and not supporting the 4G communication standard.

In the semantic hierarchical model illustrated in FIG. 1, the number of nodes between the root node and the leaf node is two. However, the number of nodes between the root node and the leaf node may not be two. Furthermore, the number of nodes between the root node and the leaf node may differ from one leaf node to another.

As described above, items may be items other than cellular phones. For example, when items are PCs, child nodes of a root node, to which the node 11 and the node 12 of FIG. 1 correspond, for example, may be groups of PCs according to the classification of the PCs (portable PCs or desktop PCs). Grandchild nodes of the root node, to which the node 8, the node 9, and the node 10 of FIG. 1 correspond, may be, for example, groups according to communication standards supported by the PCs. The communication standards in a case where an item is a PC may be different from the above-described communication standards in a case where an item is a cellular phone. The communication standards in a case where the item is the PC, for example, may not include mobile communication standards. When an item is clothes, child nodes of the root node may be, for example, groups according to the classification (for example, long sleeves or half sleeves) of the clothes. Grandchild nodes of the root node may be, for example, groups according to colors or patterns of the clothes. When an item is a wrist watch, child nodes of a root node may be, for example, targets (e.g. for men, for women, and unisex). Grandchild nodes of the root node may be, for example, groups according to driving schemes (i.e. a mechanical type and a quartz type) of wrist watches. When an item is a camera, child nodes of a root node may be, for example, classifications (e.g. a digital camera and a film camera) of cameras. Grandchild nodes of the root node may be, for example, forms (e.g. a lens integrated type or a lens interchangeable type) of cameras. When an item is a digital camera, child nodes of a root node may be, for example, forms (e.g. a lens integrated type and a lens interchangeable type) of digital cameras. Grandchild nodes of the root node may be, for example, image types (e.g. a still image, a moving image, and a still image and a moving image) of an image which can be taken. The above is merely examples. The definition of items and nodes is not limited to the above examples. Hereinafter, a description will be provided for the case in which an item is a cellular phone and nodes are defined as illustrated in FIG. 1.

Assume, in FIG. 1, that the type A is a newly released type. Assume, in FIG. 1, that the type B and the type C are types for which sufficient numbers of days have passed from the beginnings of sales. Furthermore, assume also, in FIG. 1, that the type D, the type E, the type F, and the type G are types for which sufficient numbers of days have passed from the beginnings of sales. Since the type A is a newly released type, known data for the type A (that is, sales results as used items) is not accumulated. Since the type B and the type C are types for which sufficient numbers of days have passed from the beginnings of sales, known data is sufficiently accumulated. Similarly, also for the type D, the type E, the type F, and the type G, known data is sufficiently accumulated.

Consideration is provided below for a case in which the intended to predict is a proper price when a dealer of used items distributes an item of the type A on a market as a used item in the state in which there are no sales results of the item of the type A as a used item as described above. In this case, the item of the type A is a “prediction target”, known data for the type A itself is “prediction target data”, and a learning model for the type A itself is a “prediction target learning model”. Hereinafter, a proper price when an item of a certain type is distributed on the market as a used item is referred to simply as a “proper price of a certain type”.

First, a stage in which a short period of time passes after the start of distribution of the type A and a small amount of known data for the type A (that is, prediction target data) is accumulated, that is, the stage 2 is described. In the stage 2, a sufficient amount of prediction target data is not accumulated. Accordingly, in this stage, a provider is not able to generate a prediction target learning model accurately on the basis of a prediction target data set. In the stage 2, the provider generates a higher-order learning model on the basis of a higher-order data set and predicts a proper price of the type A by using the higher-order learning model. In the present exemplary embodiment, the higher-order data set is a data set including a set of known data and a set of the prediction target data for the type B and the type C.

Next, a stage in which a sufficient time passes after the start of distribution of the type A and a sufficient amount of prediction target data is accumulated, that is, the stage 3 is described. In this stage, the provider is able to generate the prediction target learning model accurately on the basis of the prediction target data. In the stage 3, the provider predicts the proper price of the type A on the basis of the prediction target learning model.

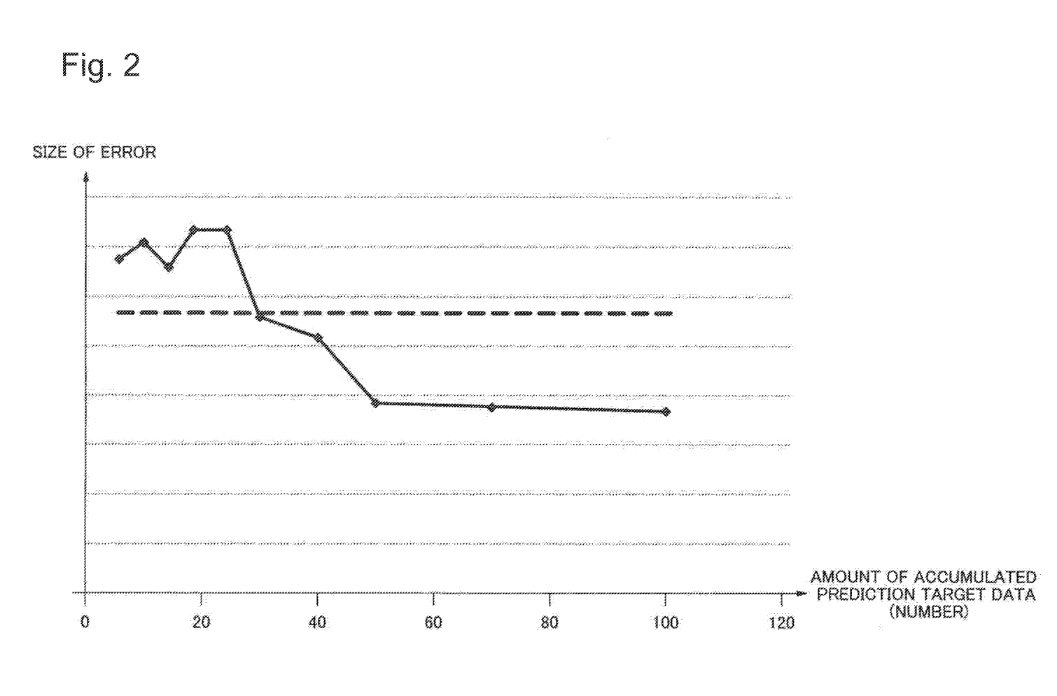

FIG. 2 is a diagram illustrating a graph indicating a transition of accuracy of the prediction target learning model and the higher-order learning model in a process in which the prediction target data is being accumulated.

In FIG. 2, a horizontal axis denotes the amount of the prediction target data (that is, a quantity indicating sales results of the item of the type A as a used item). In FIG. 2, a vertical axis denotes an absolute value of the difference (hereinafter, referred to as an “error”) between a predicted value output by a learning model, and a result value. That is, in FIG. 2, the vertical axis denotes the accuracy of the learning model (the accuracy is lower as the value of the error is larger). In FIG. 2, a polygonal line drawn by a solid line represents an error of a predicted value at which the prediction target learning model is output. In FIG. 2, a polygonal line drawn by a broken line represents an error of a predicted value at which the higher-order learning model is output.

Referring to FIG. 2, the predicted value output by the prediction target learning model is seen to have a large error and not to be stable in a stage in which the amount of the prediction target data is small. Furthermore, from FIG. 2, the predicted value output by the prediction target learning model is seen to have a small error and to be stable in the stage in which the amount of the prediction target data is small.

In a case of the example illustrated in FIG. 2, it can be said to be preferable that a provider switches a learning model to be used in prediction from the higher-order learning model to the prediction target learning model about at a crossing timing of the solid line and the broken line, that is, a timing at which about 30 pieces of prediction target data are accumulated.

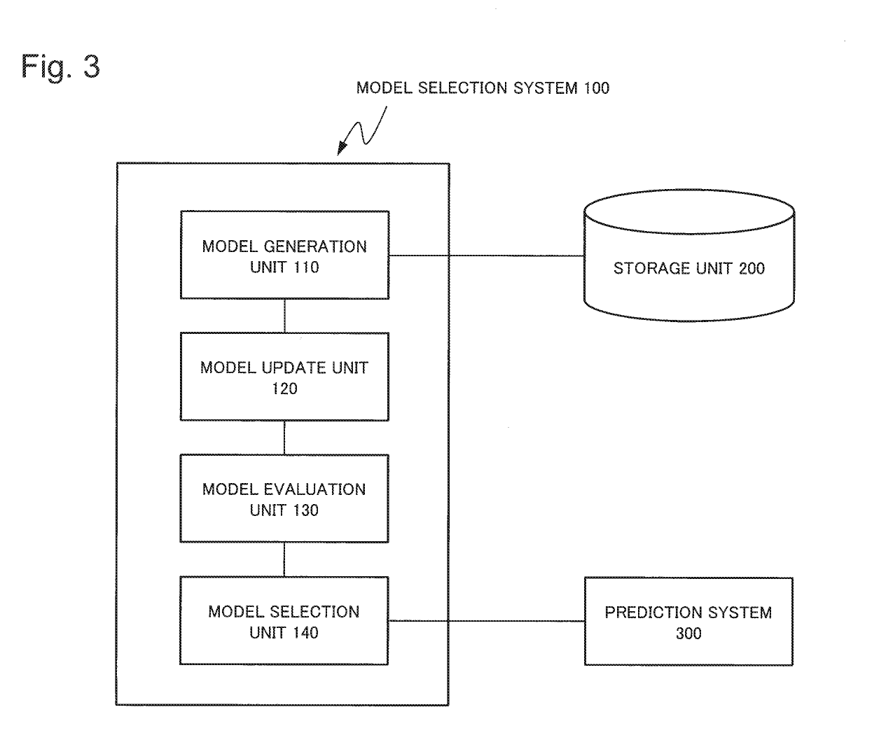

FIG. 3 is a block diagram illustrating a configuration of a model selection system 100 according to the first exemplary embodiment. As illustrated in FIG. 3, the model selection system 100 includes a model generation unit 110, a model update unit 120, a model evaluation unit 130, and a model selection unit 140. The model selection system 100 is accessibly connected with a storage unit 200. The model selection system 100 is accessibly connected with a prediction system 300.

The storage unit 200 stores a set of known data for each of the types from the type A to the type G illustrated in FIG. 1. Whenever items of any type are sold as used items, data indicating sales results of the sold used items is accumulated in the storage unit 200 as known data.

The model generation unit 110, for example, receives input of a semantic hierarchical model as illustrated in FIG. 1. The model generation unit 110 acquires a set of known data with reference to the storage unit 200. The model generation unit 110 generates learning models for each node in the semantic hierarchical model.

When the model generation unit 110 receives the semantic hierarchical model illustrated in FIG. 1, the model generation unit 110, for example, generates the following learning models.
Learning model for the type A (corresponding to a learning model for the node 1)
Learning model for the type B (corresponding to a learning model for the node 2)
Learning model for the type C (corresponding to a learning model for the node 3)
Learning model that covers the type A, the type B, and the type C (corresponding to a learning model for the node 8)
Learning model for the type D (corresponding to a learning model for the node 4)
Learning model for the type E (corresponding to a learning model for the node 5)
Learning model that covers the type D and the type E (corresponding to a learning model for the node 9)
Higher-order learning model that covers the type A, the type B, the type C, the type D, and the type E (corresponding to a learning model for the node 11)
Learning model for the type F (corresponding to a learning model for the node 6)
Learning model for the type G (corresponding to a learning model for the node 7)
Learning model that covers the type F and the type G (corresponding to a learning model for the node 10 or 12)
Learning model that covers the type A to the type G (corresponding to a learning model for the node 13)

In the following description, for example, a case in which the model generation unit 110 generates the learning model for the type A is assumed. In this case, the model generation unit 110 obtains a known data set for the type A from the storage unit 200. Then, on the basis of the obtained known data set for the type A, the model generation unit 110 generates the learning model for the type A.

In the following description, for example, a case in which the model generation unit 110 generates the learning model for the node 8 is assumed. In this case, the model generation unit 110 obtains the known data set for the type A, the known data set for the type B, and the known data set for the type C from the storage unit 200. Then, on the basis of the obtained data sets, which are the known data sets for the type A, the type B, and the type C, the model generation unit 110 generates the learning model for the node 8.

It is not necessary for the model generation unit 110 to generate learning models for all the nodes in the semantic hierarchical model. For example, when a type to be predicted is the type A, the model generation unit 110 may generate only a learning model for a node (the node 1) representing the type A, and learning models for nodes (the node 8, the node 11, and the node 13) representing higher-order groups of the type A.

The model update unit 120 updates each of the learning models at a predetermined timing. As described above, the known data is successively accumulated in the storage unit 200. The model update unit 120, for example, may update each of the learning models at a timing at which a certain amount of known data is newly accumulated in the storage unit 200.

The model evaluation unit 130 evaluates each of the learning models. A specific evaluation method is described later. It is not necessary for the model evaluation unit 130 to evaluate all the learning models related with the nodes in the semantic hierarchical model. The model evaluation unit 130 performs evaluation for at least a prediction target learning model.

The model selection unit 140 selects a learning model used when performing prediction for a prediction target from a plurality of learning models. The model selection unit 140 selects a higher-order learning model in a stage in which the amount of prediction target data is small, and selects a prediction target learning model, instead of the higher-order learning model, in a process in which the prediction target data is being accumulated. The model selection unit 140 may select the prediction target learning model at a timing at which, for example, evaluation of the prediction target learning model comes to satisfy a predetermined criterion. The model selection unit 140 may select the prediction target learning model at a timing at which the evaluation of the prediction target learning model become superior to the evaluation of the higher-order learning model.

The model selection unit 140 outputs the selected learning model to the prediction system 300.

The prediction system 300 performs prediction for a prediction target on the basis of the learning model selected by the model selection unit 140.

(Description for Example of Hardware Configuration of Model Selection System 100)

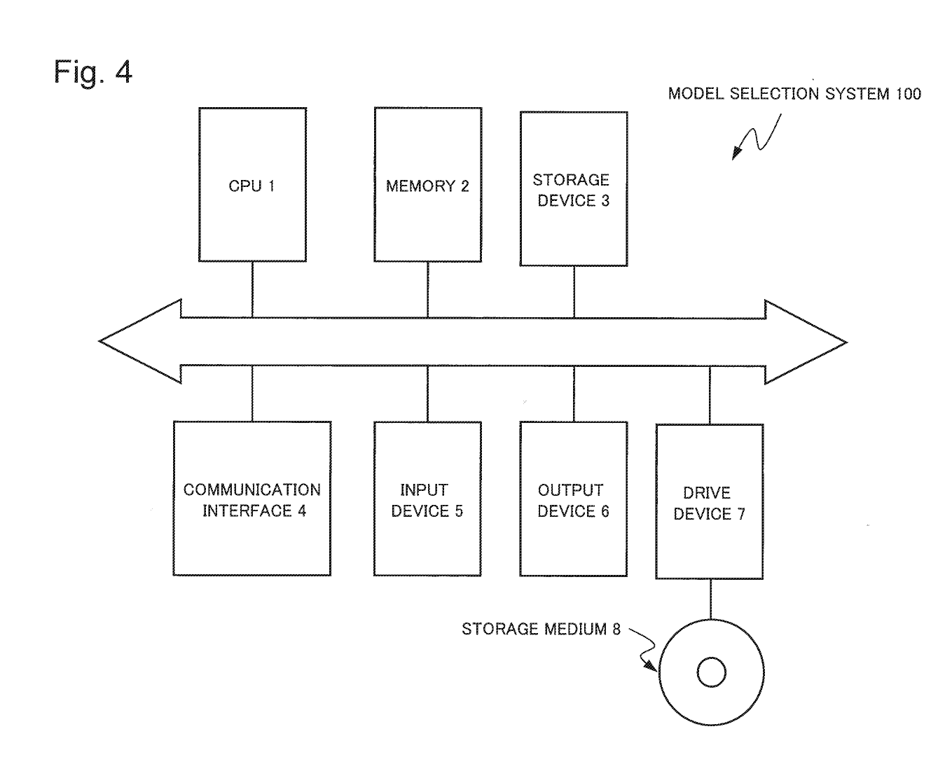

FIG. 4 is a diagram for explaining an example of a hardware configuration capable of achieving the model selection system 100 according to the first exemplary embodiment.

The hardware (for example, a computer) capable of achieving the model selection system 100 illustrated in FIG. 4 includes a CPU (Central Processing Unit) 1, a memory 2, a storage device 3, and a communication interface (I/F) 4. The model selection system 100 may further include an input device 5 and an output device 6. The functions of the model selection system 100, for example, are achieved when the CPU 1 executes a computer program (i.e. a software program, hereinafter, simply written as a “program”) read out from the memory 2. When executing the programs, the CPU 1 appropriately controls the communication interface 4, the input device 5, and the output device 6.

In the example illustrated in FIG. 4, specifically, the above-described program, for example, is stored in a storage medium 8. The CPU 1 loads the program stored in the storage medium 8 into the memory 2. The CPU 1 executes the programs loaded into the memory 2, so that the hardware (for example, a computer) having the configuration illustrated in FIG. 4 operates as the model generation unit 110, the model update unit 120, the model evaluation unit 130, and the memory selection unit 140 of the model selection system 100.

The present invention described using the present exemplary embodiment and each exemplary embodiment described later may be achieved by the non-transitory storage medium 8 such as a compact disk, in which a concerning program is stored. The program stored in the storage medium 8 is read by, for example, a drive device 7.

Communication performed by the model selection system 100, for example, is achieved by, for example, an application program controlling the communication interface 4 by using functions provided by an OS (Operating System). The input device 5, for example, is a keyboard, a mouse, or a touch panel. The output device 6, for example, is a display. The model selection system 100 may be achieved by two or more physically separated devices communicably connected with each other in a wired manner or a wireless manner.

The hardware configuration example illustrated in FIG. 4 can be applied to each exemplary embodiment described later. The model selection system 100 may be an apparatus achieved by a dedicated circuit. The model selection system 100 and hardware configurations of each functional block thereof are not limited to the above-described configurations.

Specifically, the whole or a part of the model generation unit 110, the model update unit 120, the model evaluation unit 130, and the memory selection unit 140 of the model selection system 100 may be achieved by a dedicated circuit achieving the functions thereof.

The storage medium 8, for example, may store a program for functioning as, for example, a model selection system 100A according to an exemplary embodiment described later. The CPU 1 of the computer having the configuration illustrated in FIG. 4 loads the program stored in the storage medium 8 into the memory 2. In this case, the CPU 1 executes the program loaded into the memory 2, so that the computer operates as the model generation unit 110, the model update unit 120, the model evaluation unit 130, and a memory selection unit 140A of the model selection system 100A. The model selection system 100A may be achieved using dedicated hardware. That is, the whole or a part of the model generation unit 110, the model update unit 120, the model evaluation unit 130, and the memory selection unit 140A of the model selection system 100A may be achieved by dedicated circuits achieving the functions thereof.

The storage medium 8, for example, may store a program for functioning as, for example, a model selection system 100B according to an exemplary embodiment described later. The CPU 1 of the computer having the configuration illustrated in FIG. 4 loads the program stored in the storage medium 8 into the memory 2. The CPU 1 executes the program loaded into the memory 2, so that the computer operates as a model evaluation unit 130B and a memory selection unit 140B of the model selection system 100B. The model selection system 100B may be achieved by dedicated hardware. That is, the whole or a part of the model evaluation unit 130B and a memory selection unit 140B of the model selection system 100B may be achieved by dedicated circuits achieving the functions thereof.

(Description of Operations of Model Selection System 100)

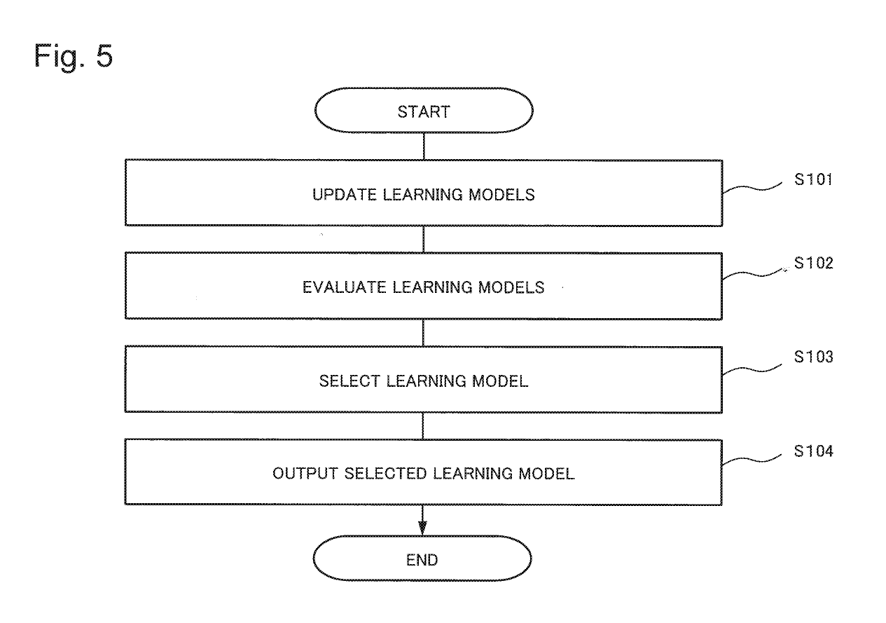

Next, an example of the operations of the model selection system 100 according to the first exemplary embodiment is described. FIG. 5 is a flowchart for explaining an example of the operation of the model selection system 100. The model update unit 120 updates learning models on the basis of a set of known data stored in the storage unit 200 (step S101). The model evaluation unit 130 evaluates the updated learning models (step S102). The model selection unit 140 selects a learning model used for prediction of a prediction target from the learning models on the basis of a predetermined criterion (step S103). The model selection unit 140 outputs the selected learning model (step S104).

(Description of Effects of Model Selection System 100)

By the model selection system 100 according to the first exemplary embodiment, in a process of a transition from a stage in which there is very little or no known data for a prediction target to a stage in which a sufficient amount of known data for the prediction target is accumulated, it is possible to predict a feature of the prediction target accurately. This is because the model selection unit 140 selects a prediction target learning model, instead of a higher-order learning model, at a timing at which evaluation results of the prediction target learning model comes to satisfy a predetermined criterion. If not so, this is because the model selection unit 140 selects the prediction target learning model, instead of the higher-order learning model, at a timing at which evaluation results of the prediction target learning model become superior to evaluation results of the higher-order learning model.

(Description of Details of Evaluation)

Next, a specific method of the model evaluation unit 130 evaluating learning models is described. An evaluation method described below is merely a specific example. The following description is not for limitedly construing evaluation in the present exemplary embodiment.

In the evaluation of learning models, the model evaluation unit 130 evaluates the learning models by using at least one of the following four standpoints.

(Standpoint 1): Evaluating a learning model more highly as the size of an error of a predicted value outputted by the learning model becomes smaller.

(Standpoint 2): Evaluating a learning model more highly as the size of an error of a predicted value outputted by the learning model becomes more stable.

(Standpoint 3): Evaluating a learning model more highly as the amount of known data serving as a base of generating the learning model become larger.

(Standpoint 4): Evaluating a learning model according to the degree of abstraction, with respect to the prediction target, of the learning model used for predicting a prediction target, that is, according to how many layers are positioned above the prediction target. According to the standpoint 4, there is a case of evaluating a learning model more highly as the degree of abstraction becomes higher and a case of devaluating a learning model lower as the degree of abstraction becomes higher.

It is more preferable that the model evaluation unit 130 combines two or more of the aforementioned standpoints with one another, thereby evaluating learning models. In this case, the model evaluation unit 130 may give respective weights to the aforementioned standpoints and then combine the standpoints with one another. The model evaluation unit 130 may give weights to the standpoints dependently on a feature of a prediction target, the use of a prediction result, or the like.

The model evaluation unit 130 evaluates learning models preferably by using N-fold cross-validation. The N division cross validation is a known method. Hereinafter, the N-fold cross-validation is described briefly.

The model evaluation unit 130 divides a known data set used for generating a learning model that is an evaluation target into N blocks. When doing so, the model evaluation unit 130 divides the known data set such that approximately as the same amount of known data is included in each of the blocks as possible. For example, when the known data set is a set of 500 pieces of known data and N is 5, the model evaluation unit 130 divides the known data set into five blocks. When doing so, the number of a piece of the known data included in each block is 100 or about 100.

The model evaluation unit 130 employs known data included in one of the five blocks as test data and employs known data included in the remaining four blocks as training data. On the basis of the training data and values of an explanation variable included in the test data, the model evaluation unit 130 predicts values of an objective variable included in the test data. The model evaluation unit 130 compares the predicted values with actual values of the objective variable included in the test data. The model evaluation unit 130, for example, calculates an average value of errors of the predicted values and the actual values.

The model evaluation unit 130 repeats the above-described process (that is, validation) N times (five times in the above-described example) while switching a block used as the test data. The model calculation unit outputs an error average value and an error distribution value in the validation of the N times (the five times in the above-described example).

For example, the model evaluation unit 130 may evaluate whether both the error average value and the error distribution value, which are calculated using the N-fold cross-validation as the evaluation results of the prediction target learning model, satisfy their respective criterion determined in advance. When both the error average value and the error distribution value satisfy their respective criterion, the model evaluation unit 130 may select the prediction target learning model instead of the higher-order learning model.

As above, the specific method of the model evaluation unit 130 when evaluating learning models is described above.

(Description of Design when Generating Higher-Order Learning Model)

Next, a description will be provided for a device of the model generation unit 110 when generating a higher-order learning model. A similar device is also performed when the model update unit 120 updates the higher-order learning model.

Assume that, in the semantic hierarchical model illustrated in FIG. 1, for example, 50 pieces of known data for the type A are accumulated, 100 pieces of known data for the type B are accumulated, and 200 pieces of known data for the type C are accumulated. Consideration is provided below for a case in which the model generation unit 110 generates, in this condition, a higher-order learning model of a group including the type A, the type B, and the type C.

Here, assume that the model generation unit 110 generates the higher-order learning model on the basis of the total 350 pieces of known data including the 50 pieces of known data for the type A, the 100 pieces of known data for the type B, and the 200 pieces of known data for the type C. In this case, in the generated higher-order learning model, features of the types are reflected with strengths according to the numbers of the pieces of known data. The generated higher-order learning model becomes a learning model in which the features of the type C are strongly reflected and the features of the type A are reflected not so much. This is not proper as a higher-order learning model.

The model generation unit 110 obtains approximately as the same amount of known data as possible for each of the type A, the type B, and the type C, and uses the obtained known data as a higher-order data set. Then, on the basis of the higher-order data set including approximately as the same amount of known data as possible for each of the types, the model generation unit 110 generates a higher-order learning model.

For example, in the above-described example, the model generation unit 110 obtains, for example, 50 pieces of known data for each of the type A, the type B, and the type C, that is, the total 150 pieces of known data. Then, on the basis of the obtained 150 pieces of known data, the model generation unit 110 generates a higher-order learning model.

Since the model generation unit 110 generates the higher-order learning model in this way, the higher-order learning model becomes a learning model in which features of types used for learning the higher-order learning model by using the known data are equally reflected. When the 200 pieces of known data for the type C are accumulated, the model generation unit 110 may randomly select 50 pieces of known data from the 200 pieces of known data.

As above, the device in a case where the model generation unit 110 generates the higher-order learning model is described above.

(Description of Device in a Case of Selecting Learning Model)

Assume that the semantic hierarchical model has at least three layers. In this case, the model selection unit 140 may select one learning model from a prediction target learning model, a higher-order learning model, and a further higher-order learning model. The prediction target learning model, for example, corresponds to the learning model for the node 1 in FIG. 1. The higher-order learning model, for example, corresponds to the learning model for the node 8 in FIG. 1. The further higher-order learning model, for example, corresponds to the learning model for the node 11 in FIG. 1.

(Description of Variation of Semantic Hierarchical Model)

The semantic hierarchical model is not limited to the tree structure as illustrated in FIG. 1. Hereinafter, a specific example of the semantic hierarchical model, other than the tree structure, will be described.

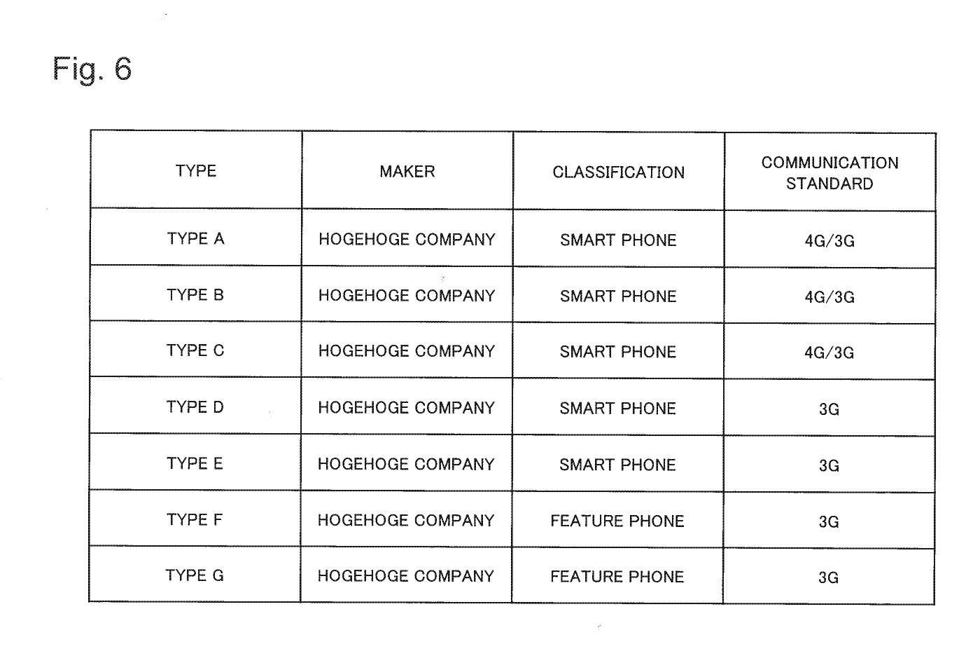

FIG. 6 is a diagram illustrating a specific example of the semantic hierarchical model conceptually exemplified as a table. An example illustrated in FIG. 6 is an example when an item is a cellular phone. Information illustrated in FIG. 6 corresponds to the information illustrated in FIG. 1. FIG. 6 illustrates 7 types of items from a type A to a type G. As illustrated in FIG. 6, each of the types has three attributes including a maker, a classification, and a communication standard. The classification of the cellular phone indicates whether the cellular phone is a smart phone or a feature phone.

More specifically, in FIG. 6, the type A, the type B, and the type C are items manufactured by Hogehoge Company and are smart phones supporting the 4G and 3G communication standards. As illustrated in FIG. 6, the type D and the type E are items manufactured by Hogehoge Company and are smart phones supporting the 3G communication standard. As illustrated in FIG. 6, the type F and the type G are items manufactured by Hogehoge Company and are feature phones supporting the 3G communication standard. These relations are similar to those of the semantic hierarchical model described with reference to FIG. 1.

Here, assume that the type A is a type that is a prediction target. In this case, concerning the type B and the type C, all attribute values of the three attributes are common to the type A. Accordingly, the type B and the type C are items similar to the type A.

Thus, sets of known data for the type A, the type B, and the type C corresponds to a higher-order data set for the type A.

Each of the types from the type A to the type E have at least two same attribute values of the three attributes as those of the type A. Accordingly, a set of known data for each of the type A, the type B, the type C, the type D, and the type E corresponds to a higher-order data set by two layers from the type A as indicated by the semantic hierarchical model illustrated in FIG. 1.

As described above, the semantic hierarchical model is not necessarily represented by the tree structure. A hierarchical structure may be defined according to the degree of commonality between attribute values of a prediction target and attribute values of other subjects. As above, the specific example of the semantic hierarchical model, other than the tree structure, is described.

(Another Variation 1)

In the present exemplary embodiment, the use of a learning model is not limited only to prediction. A learning model may be used for discovering useful knowledge (that is, knowledge discovery), discovering an optimal solution for solving a problem (that is, optimization), finding sample data different than usual (that is, abnormality detection), and the like.

When a learning model is used for these uses, the model selection system 100 is able to analyze a property of an analysis target accurately during a process of a transition from a stage in which there is very little or no known data for the analysis target to a stage in which a sufficient amount of known data is accumulated.

### Second Exemplary Embodiment

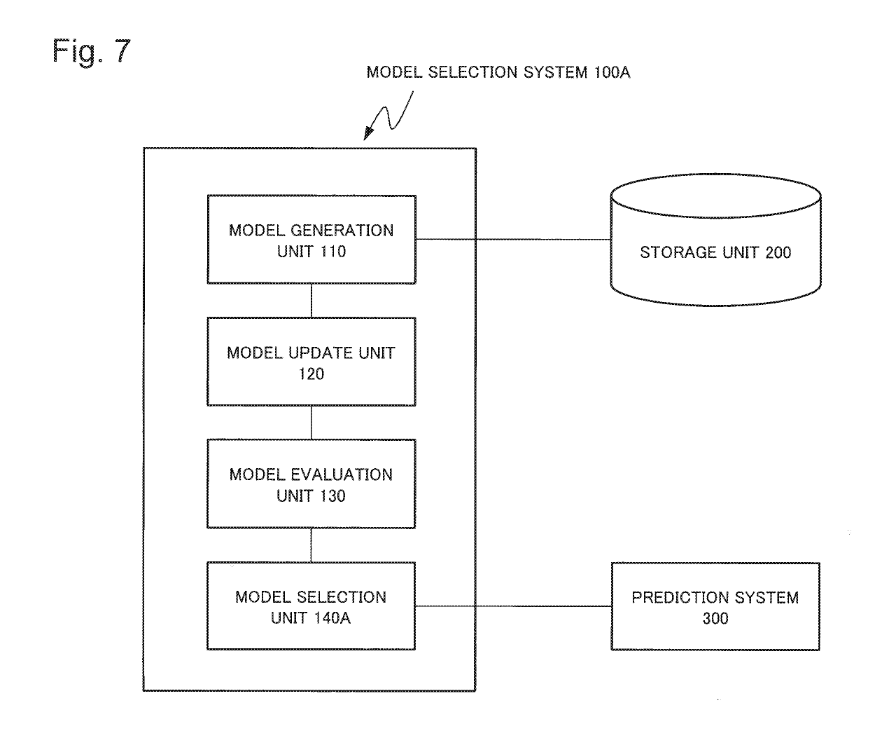

Next, a second exemplary embodiment based on the above-described first exemplary embodiment is described. FIG. 7 is a block diagram illustrating a configuration of the model selection system 100A in the second exemplary embodiment. The model selection system 100A includes the model selection unit 140A instead of the model selection unit 140 in the first exemplary embodiment. The same reference signs are assigned to substantially the same elements as those illustrated in FIG. 3, and a description thereof is omitted.

In order to facilitate understanding, the following terms are defined.

(Similar data set): The similar data set is a set of a piece of or a plurality of pieces of similar data.

(Similar learning model): The similar learning model is a learning model generated on the basis of a similar data set.

In the first exemplary embodiment, the case, in which the model selection unit 140 selects any one of the prediction target learning model and the higher-order learning models as a learning model for predicting a prediction target, is described.

In the second exemplary embodiment, the model selection unit 140A selects any one of a prediction target model and similar learning models as a learning model for predicting a prediction target.

In the semantic hierarchical model illustrated in FIG. 1, when the type A is a prediction target, the similar data set may be a set of known data for the type B. Alternatively, the similar data may be a set of known data for the type C. Alternatively, the similar data set may be a set of known data for the type B and the type C.

The model selection unit 140 selects a similar learning model in a stage in which the amount of prediction target data is small, and selects a prediction target learning model, instead of the similar learning model, in a process in which the prediction target data is being accumulated. For example, the model selection unit 140A may select the prediction target learning model at a timing at which evaluation of the prediction target learning model comes to satisfy a predetermined criterion. Alternatively, the model selection unit 140A may select the prediction target learning model at a timing at which the evaluation of the prediction target learning model becomes higher than evaluation of the similar learning model.

In accordance with the model selection system 100A according to the second exemplary embodiment, in a process of a transition from a stage in which there is very little or no known data for a prediction target to a stage in which a sufficient quantity of known data for the prediction target is accumulated, it is possible to predict a property of the prediction target accurately.

### Third Exemplary Embodiment

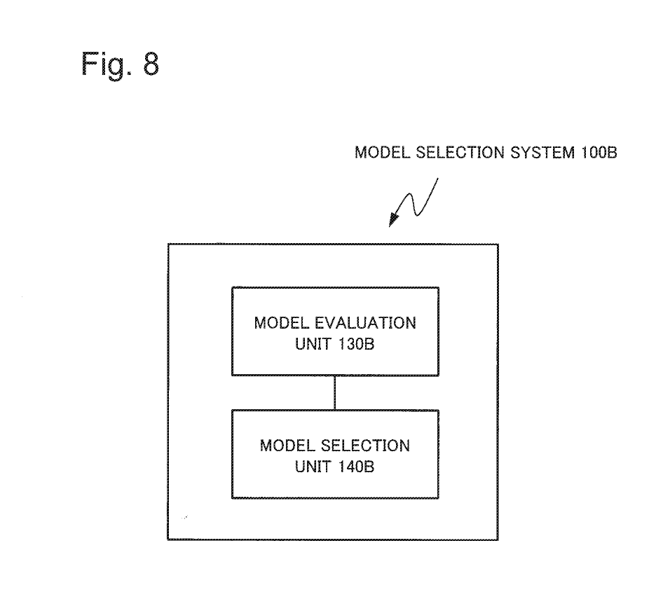

FIG. 8 is a block diagram illustrating a configuration of the model selection system 100B according to a third exemplary embodiment. The present exemplary embodiment represents a minimum configuration of the above-described first and second exemplary embodiments. As illustrated in FIG. 8, the model selection system 100B includes the model evaluation unit 130B and the model selection unit 140B.

The model evaluation unit 130B evaluates learning models. The model evaluation unit 130B may evaluate learning models by using a method similar to the above-described method by which the model evaluation unit 130 of the first and second exemplary embodiments evaluates learning models.

The model selection unit 140B selects one of a prediction target learning model and a higher-order learning model on the basis of a result of evaluation. The model selection unit 140B may select a learning model by using a method similar to the above-described method by which the model selection unit 140 of the first exemplary embodiment or the model selection unit 140A of the second exemplary selects a learning model.

A learning model is information representing regularity found between values of an objective variable and values of an explanation variable explaining the values of the objective variable. A target learning model is a learning model generated on the basis of a target data set which is a set of a plurality of pieces of target data. A higher-order learning model is a learning model generated on the basis of a higher-order data set which is a set of a plurality of pieces of target data and a plurality of pieces of similar data. The target data is information in which values of an objective variable for a specific target are associated with values of an explanation variable explaining the values of the objective variable. The similar data is information in which values of an objective variable for a target similar to a specific target with values of an explanation variable explaining the values of the objective variable.

The above-described exemplary embodiments can be embodied through appropriate combinations thereof.

The block division illustrated in each of the block diagrams is a configuration for the convenience of description. The present invention described using each of the exemplary embodiments as an example is not limited to the configuration illustrated in each of the block diagrams at the time of implementation thereof.

While the exemplary embodiments of the present invention are described above, the above-described exemplary embodiments are for facilitating the understanding of the present invention and are not to intend the present invention to be limitedly construed. The present invention can be changed and modified without departing from the gist thereof and also includes equivalents thereof.

Supplementary notes of reference embodiments are as follows.

The whole or a part of the aforementioned exemplary embodiments is also written in the following supplementary notes, but is not limited thereto.

(Supplementary Note 1)

A learning model selection system comprising:

a model evaluation unit that evaluates a learning model; and

a model selection unit that selects one learning model from a target learning model and a higher-order learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the higher-order learning model is a learning model generated on a basis of a higher-order data set which is a set of a plurality of pieces of the target data and a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

(Supplementary Note 2)

The learning model selection system according to Supplementary note 1, wherein

the model selection unit selects the one target model from the target learning model and the higher-order learning model on a basis of the result of the evaluation as a learning model used when predicting the specific target, and

the learning model is a function of predicting the value of the objective variable, the values of the explanation variable being input to the function.

(Supplementary Note 3)

The learning model selection system according to Supplementary note 1 or 2, further comprising:

a model update unit that updates the target learning model on a basis of the target data set, and updating the higher-order learning model on a basis of the higher-order data set in a process in which the target data is accumulated.

(Supplementary Note 4)

The learning model selection system according to Supplementary note 3, wherein

the higher-order data set is a set including the target data and first to n-th pieces of similar data (n is a natural number), and

the model update unit updates the higher-order learning model on a basis of a higher-order data set in which an amount of the target data and an amount of each of the first to n-th pieces of the similar data are approximately equal to each other.

(Supplementary Note 5)

The learning model selection system according to any one of Supplementary notes 1 to 4, wherein

the model selection unit selects the higher-order learning model in a stage in which the amount of the target data is small, and selects the target learning model, instead of the higher-order learning model, at a timing at which the evaluation of the target learning model satisfies a predetermined criterion in the process in which the target data is accumulated.

(Supplementary Note 6)

The learning model selection system according to any one of Supplementary notes 1 to 4, wherein

the model selection unit selects the higher-order learning model in a stage in which the amount of the target data is small, and selects the target learning model, instead of the higher-order learning model, at a timing at which evaluation of the target learning model has exceeded evaluation of the higher-order learning model in the process in which the target data is accumulated.

(Supplementary Note 7)

The learning model selection system according to any one of Supplementary notes 3 to 6, wherein,

in a semantic hierarchical model having at least three layers,

a first node belonging to a certain layer in the semantic hierarchical model corresponds to the specific target and the target data set,

a second node, which is a node including the first node, corresponds to the higher-order data set,

a third node further including the second node corresponds to a second higher-order data set,

the model generation unit receives input of the semantic hierarchical model, and generates the target learning model corresponding to the first node, the higher-order learning model corresponding to the second node, and a second higher-order learning model corresponding to the third node, in the semantic hierarchical model,

the model update unit updates the target learning model, the higher-order learning model, and the second higher-order learning model in the process in which the target data is accumulated, and

the model selection unit selects a model whose evaluation is high rated from the target learning model, the higher-order learning model, and the second higher-order learning model in the process in which the target data is accumulated.

(Supplementary Note 8)

The learning model selection system according to any one of Supplementary notes 1 to 7, wherein

the model evaluation unit evaluates the learning model on a basis of an average value and a distribution value of values indicating errors, which are calculated using an N-fold cross-validation method.

(Supplementary Note 9)

The learning model selection system according to any one of Supplementary notes 1 to 7, wherein

the model evaluation unit evaluates the learning model with an evaluation index indicating how many layers a node corresponding to the learning model is separated from the first node in the semantic hierarchical model.

(Supplementary Note 10)

A learning model selection method comprising:

evaluating a learning model; and

selecting one target model from a target learning model and a higher-order learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the higher-order learning model is a learning model generated on a basis of a higher-order data set which is a set of a plurality of pieces of the target data and a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

(Supplementary Note 11)

A program or a computer readable storage medium storing the program, the program causing a computer to execute:

first processing of evaluating a learning model; and

second processing of selecting one learning model from a target learning model and a higher-order learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the higher-order learning model is a learning model generated on a basis of a higher-order data set which is a set of a plurality of pieces of the target data and a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

(Supplementary Note 12)

A learning model selection system comprising:

a model evaluation unit that evaluates a learning model; and

a model selection unit that selects one learning model from a target learning model and a similar learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the similar learning model is a learning model generated on a basis of a similar data set which is a set of one or a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

(Supplementary Note 13)

The learning model selection system according to Supplementary note 12, wherein

the model selection unit selects the one target model from the target learning model and the similar learning model on a basis of the result of the evaluation as a learning model used when predicting the specific target, and

the learning model is a function of predicting the value of the objective variable, the values of the explanation variable being input to the function.

(Supplementary Note 14)

The learning model selection system according to Supplementary note 12 or 13, further comprising:

a model update unit that updates the target learning model on a basis of the target data set, and updates the similar learning model on a basis of the similar data set in a process in which the target data is accumulated.

(Supplementary Note 15)

The learning model selection system according to any one of Supplementary notes 12 to 14, wherein

the model selection unit selects the similar learning model in a stage in which the amount of the target data is small, and selects the target learning model, instead of the similar learning model, at a timing at which the evaluation of the target learning model satisfies a predetermined criterion in the process in which the target data is accumulated.

(Supplementary Note 16)

The learning model selection system according to any one of Supplementary notes 12 to 14, wherein

the model selection unit selects the similar learning model in a stage in which the amount of the target data is small, and selects the target learning model, instead of the similar learning model, at a timing at which evaluation of the target learning model has exceeded evaluation of the similar learning model in the process in which the target data is accumulated.

(Supplementary Note 17)

The learning model selection system according to any one of Supplementary notes 12 to 16, wherein

the model evaluation unit evaluates the learning model on a basis of an average value and a distribution value of values indicating errors, which are calculated using an N-fold cross-validation method.

(Supplementary Note 18)

A learning model selection method comprising:

evaluating a learning model; and

selecting one learning model from a target learning model and a similar learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the similar learning model is a learning model generated on a basis of a similar data set which is a set of one or a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

(Supplementary Note 19)

A program or a computer readable storage medium storing the program, the program causing a computer to execute:

first processing of evaluating a learning model; and

second processing of selecting one learning model from a target learning model and a similar learning model on a basis of a result of the evaluation,

wherein the learning model is information representing regularity found between values of an objective variable and values of an explanation variable explaining the values of the objective variable,

the target learning model is a learning model generated on a basis of a target data set which is a set of a plurality of pieces of target data,

the similar learning model is a learning model generated on a basis of a similar data set which is a set of one or a plurality of pieces of similar data,

the target data is information in which values of an objective variable for a specific target are associated with values of an explanation variable explaining the values of the objective variable, and

the similar data is information in which values of an objective variable for a target similar to the specific target are associated with values of an explanation variable explaining the values of the objective variable.

As above, the present invention has been described with reference to exemplary embodiments; however, the present invention is not limited to the aforementioned exemplary embodiments. Various modifications which can be understood by a person skilled in the art can be made in the configuration and details of the present invention within the scope of the present invention.

This application claims priority based on U.S. provisional application No. U.S. 61/971,597 filed on Mar. 28, 2014, the disclosure of which is incorporated herein in its entirety by reference.

### INDUSTRIAL APPLICABILITY

The present invention can be applied to data mining and the like.

### REFERENCE SIGNS LIST

1 CPU
2 memory
3 storage device
4 communication interface
5 input device
6 output device
7 drive device
8 storage medium
100 model selection system
100A model selection system
100B model selection system
110 model generation unit
120 model update unit
130 model evaluation unit
130B model evaluation unit
140 model selection unit
140A model selection unit
140B model selection unit
200 storage unit
300 prediction system

What is claimed is:

1. A learning model selection system comprising:
a memory that stores a set of instructions; and
at least one Central Processing Unit (CPU) configured to execute the set of instructions to:
evaluate a learning model; and
select one learning model from a target learning model and a higher-order learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the higher-order learning model is a learning model generated on a basis of a higher-order data set which is a set of a plurality of pieces of the target data and a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.

2. The learning model selection system according to claim 1, wherein
the at least one CPU is further configured to:
select the one target model from the target learning model and the higher-order learning model on a basis of the result of the evaluation as a learning model used when predicting the specific target, and
the learning model is a function of predicting the value of the objective variable, the values of the explanation variable being input to the function.

3. The learning model selection system according to claim 1, wherein
the at least one CPU is further configured to:
update the target learning model on a basis of the target data set, and update the higher-order learning model on a basis of the higher-order data set in a process in which the target data is accumulated.

4. The learning model selection system according to claim 3, wherein
the higher-order data set is a set including the target data and first to n-th pieces of similar data (n is a natural number), and
the at least one CPU is further configured to:
update the higher-order learning model on a basis of a higher-order data set in which an amount of the target data and an amount of each of the first to n-th pieces of the similar data are approximately equal to each other.

5. The learning model selection system according to claim 1, wherein
the at least one CPU is further configured to:
select the higher-order learning model in a stage in which the amount of the target data is small, and select the target learning model, instead of the higher-order learning model, at a timing at which the evaluation of the target learning model satisfies a predetermined criterion in the process in which the target data is accumulated.

6. The learning model selection system according to claim 1, wherein
the at least one CPU is further configured to:
select the higher-order learning model in a stage in which the amount of the target data is small, and select the target learning model, instead of the higher-order learning model, at a timing at which evaluation of the target learning model has exceeded evaluation of the higher-order learning model in the process in which the target data is accumulated.

7. The learning model selection system according to claim 3, wherein,
in a semantic hierarchical model having at least three layers,
a first node belonging to a certain layer in the semantic hierarchical model corresponds to the specific target and the target data set,
a second node, which is a node including the first node, corresponds to the higher-order data set,
a third node further including the second node corresponds to a second higher-order data set, and
the at least one CPU is further configured to:
receive input of the semantic hierarchical model, and generates the target learning model corresponding to the first node, the higher-order learning model corresponding to the second node, and a second higher-order learning model corresponding to the third node, in the semantic hierarchical model,
update the target learning model, the higher-order learning model, and the second higher-order learning model in the process in which the target data is accumulated, and
select a model whose evaluation is high rated from the target learning model, the higher-order learning model, and the second higher-order learning model in the process in which the target data is accumulated.

8. The learning model selection system according to claim 1, wherein
the at least one CPU is further configured to:
evaluate the learning model on a basis of an average value and a distribution value of values indicating errors, which are calculated using an N-fold cross-validation method.

9. The learning model selection system according to claim 1, wherein
the at least one CPU is further configured to:
evaluate the learning model with an evaluation index indicating how many layers a node corresponding to the learning model is separated from the first node in the semantic hierarchical model.

10. A learning model selection method comprising:
evaluating a learning model; and
selecting one target model from a target learning model and a higher-order learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the higher-order learning model is a learning model generated on a basis of a higher-order data set which is a set of a plurality of pieces of the target data and a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.

11. A non-transitory computer readable storage medium storing a program causing a computer to execute:
first processing of evaluating a learning model; and
second processing of selecting one learning model from a target learning model and a higher-order learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the higher-order learning model is a learning model generated on a basis of a higher-order data set which is a set of a plurality of pieces of the target data and a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.

12. A learning model selection system comprising:
a memory that stores a set of instructions; and
at least one Central Processing Unit (CPU) configured to execute the set of instructions to:
evaluate a learning model; and
select one learning model from a target learning model and a similar learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the similar learning model is a learning model generated on a basis of a similar data set which is a set of one or a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.

13. A learning model selection method comprising:
evaluating a learning model; and
selecting one learning model from a target learning model and a similar learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the similar learning model is a learning model generated on a basis of a similar data set which is a set of one or a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.

14. A non-transitory computer readable storage medium storing a program causing a computer to execute:
first processing of evaluating a learning model; and
second processing of selecting one learning model from a target learning model and a similar learning model on a basis of a result of the evaluation,
wherein the learning model is information representing regularity found between values of an objective variable and values of an explanation variable explaining the values of the objective variable,
the target learning model is a learning model generated on a basis of a target data set which is a set of a plurality of pieces of target data,
the similar learning model is a learning model generated on a basis of a similar data set which is a set of one or a plurality of pieces of similar data,
the target data is information in which values of an objective variable for a specific target are associated with values of an explanation variable explaining the values of the objective variable, and
the similar data is information in which values of an objective variable for a target similar to the specific target are associated with values of an explanation variable explaining the values of the objective variable.
